(19) United States
(12) Patent Application Publication
(10) Pub. No.: US 2014/0076670 A1
(43) Pub. Date: Mar. 20, 2014

(54) ELEVATOR HAVING A MINIMAL ELEVATOR SHAFT WELL DEPTH AND A PERMANENT PROTECTIVE SPACE

(71) Applicant: Markus Henseler, Immensee (CH)

(72) Inventor: Markus Henseler, Immensee (CH)

(73) Assignee: INVENTIO AG, Hergiswil (CH)

(21) Appl. No.: 14/006,750

(22) PCT Filed: Mar. 21, 2012
(86) PCT No.: PCT/EP2012/001244

§ 371 Date: Dec. 2, 2013

(30) Foreign Application Priority Data
Mar. 21, 2011 (CH) 0468/11
Mar. 21, 2011 (CH) 0469/11
May 18, 2011 (CH) 0842/11

(51) Int. Cl. B66B 5/00

(52) U.S. Cl. CPC B66B 5/0056
USPC 187/331

(57) ABSTRACT

The elevator has, when the elevator car is in its lowermost access level, no elevator shaft pit or one with absolute minimal depth but complies with regulations with respect to protective spaces against the risk of being crushed. The elevator car is movable in an elevator shaft with shaft doors to several access levels. Maintenance operations can be carried out both on the elevator car or from the interior of the elevator car. Access to the region below the elevator car is possible in that at least the lowermost shaft door is permanently locked, whilst all upper shaft doors can have emergency unlocking means. The at least lowermost shaft door is thus permanently locked, with the exception of the state in which the elevator car is in a stopped state, or is stopped, opposite it. The required permanent protective space consists of the entire interior of the elevator car.

### FIELD

This invention relates to an elevator which has either no shaft pit at all or, however, only an elevator shaft pit with minimal pit depth.

### BACKGROUND

For constructional reasons in most conventional elevator constructions the region above or the region below the elevator car has to be accessible and, in particular, regardless of where the elevator car happens to be located. If the region below the elevator car is to be accessible, there is the risk that a person, who is present there, is injured by downward travel of the elevator car unintentionally taking place. Safety precautions are therefore necessary to reliably prevent such an event. Accordingly, a temporary or permanent protective space has to be present of at least the size of a block F with the minimum dimensions of 0.5 meters×0.6 meters×0.8 meters on the upper car side or 0.5 meters×0.5 meters×1.0 meter on the lower car side so that even in the case of an upward or downward movement—which in fact is highly improbable—of the elevator car a service operative would be enclosed by the protective space and therefore protected from injuries. These protective measures as well as the constructions of most elevators prevent elevator cars from being able to be moved down until quite close to the shaft floor or to be moved in upward direction until quite close below the shaft ceiling. In other words, the elevator car is always longer by a certain minimum dimension than the effective travel path of the elevator car and, more precisely, also longer than the effective maximum distance between elevator car roof in the uppermost position of the elevator car to below the floor of the elevator in its lowermost position. This fact in many cases makes installation of an elevator impossible, because it is not possible to realize the shaft pit to the necessary depth or the shaft head to prescribed shaft head height for constructional reasons.

As a central prescription it is necessary in new elevator installations to avoid risk of crushing in the end settings of the elevator car, thus by free spaces or protective niches. Due to the wording of No. 2.2 in the Lifts Ordinance and EEC lift guidelines this means that for lawmakers optimum safety is achieved with a compulsory prescribed protective space. Thus, in Swiss Lift Ordinance 2.2 it states with respect to danger to persons outside the elevator car, state of 1 Jul. 2010: “Elevators are to be so designed and constructed that risks of crushing in the end settings of the elevator car are excluded. This object is achieved if a free space or a protective niche is present either side of the end settings. If in exceptional cases, particularly in existing buildings, this solution cannot be realized, then other suitable means for avoidance of this risk can be provided, in which case the State Secretary for Economy is granted the possibility of prior consent”.

The region below the elevator car in the lowermost access level represents a particular problem. Since it can commonly happen that there is somebody standing in the shaft pit, thus on the floor of the lift elevator shaft, whether for maintenance purposes or cleaning purposes, strictly prescribed temporary or permanent protective precautions must be present to reliably prevent this person from being able to be injured or crushed in the case of unintended downward travel of the elevator car.

### SUMMARY

An object of the present invention is accordingly to create an elevator without an elevator shaft pit or with a minimal elevator shaft pit depth, which nevertheless may permit the prescriptions of the Elevator Ordinance with respect to free spaces against the risk of crushing to be fulfilled.

This object is fulfilled by an elevator with an elevator car which is movable in an elevator shaft to a plurality of access levels, and with a plurality of shaft doors which are arranged on the respective access levels and close off access to the elevator shaft. The elevator is distinguished by the fact that at least the shaft door of the lowermost access level does not have emergency unlocking means or is permanently locked.

By emergency unlocking means there is understood here an unlocking device which is actuable by a service operative for inspection or maintenance purposes from outside the elevator shaft in order to unlock a shaft door and thus free access to the elevator shaft. The emergency unlocking means is usually designed in such a manner that a service operative can unlock the emergency unlocking means by way of a box spanner which is introducible into a spanner opening in the region of a shaft door to be opened. The invention is not confined to this concrete embodiment of emergency unlocking means. It is open to the expert to realize further alternative embodiments of emergency unlocking means.

By permanently locked shaft door there is to be understood in connection with the present invention a shaft door which does not have emergency unlocking means. Accordingly, a permanently locked shaft door is not unlockable outside the elevator shaft for inspection or maintenance purposes. Obviously, a shaft door lying on an access level moved to by an elevator car is temporarily unlocked in order to free access for passengers into or out of the elevator car. Moreover, provision is made for temporarily unlocking a permanently locked shaft door for the purposes of evacuation of passengers trapped in the elevator car. For that purpose the permanently locked shaft door can be unlocked from the interior of the elevator shaft or from the elevator car interior. In the case of evacuation a permanently locked shaft door is equally unlockable by way of a control of the elevator if the shaft door is appropriately furnished with an electromechanically actuable unlocking device. The control is then preferably set by a service operative into an evacuation mode in which the temporary unlocking of a permanently locked shaft door is only unlockable. In normal operation a permanently locked shaft door thus remains always locked apart from the above-mentioned exception of an elevator car standing opposite and is also not unlockable from outside the elevator shaft for inspection or maintenance purposes.

By access to the elevator shaft there is understood in connection with the invention a capability of walking into the elevator shaft on the shaft floor or on the car roof, wherein access to the shaft floor is made impossible by technical measures. For example, falling into the elevator shaft below an elevator car onto the shaft floor from an access level above the lowermost access level does not count as access to the elevator shaft.

An advantage of the permanently lockable shaft door on the lowermost access level is that access to the shaft pit is denied and thereby access to the region below the elevator car is made impossible. Consequently, a protective space does not have to be provided below the elevator car and a minimal elevator shaft pit depth can be realized. In a particularly advantageous design of the elevator shaft the shaft pit can even be eliminated.

By shaft pit there is understood here that sub-region of the elevator shaft which in the case of a stop of the elevator car at the lowermost access level lies below the elevator car.

The elevator is designed so that all maintenance operations to devices in the interior of the elevator shaft can be carried out from the elevator car or by way of the elevator car. Accordingly, the permanent protective space F consists of the entire interior of the elevator car itself or is formed by way of the elevator car.

In a preferred embodiment of the elevator one or more shaft doors above the shaft doors of the lowermost development plane have emergency unlocking means.

In a particularly preferred embodiment of the elevator solely the shaft door of the uppermost access level has emergency unlocking means or all shaft doors of access levels thereunder are permanently locked. It is thus ensured that access to the shaft can take place only above the elevator car or in the elevator car.

In yet another, particularly preferred embodiment of the elevator all shaft doors are permanently lockable. With such a configuration a particularly deep or minimal shaft head height is additionally capable of realization, since also the region above the elevator car remains denied to the service operative for access purposes and thus the protective space F, which is to be provided permanently, above the elevator car is eliminated.

If the elevator car stands in its lowermost access level and the distance from the floor of the elevator shaft disposed thereunder is, for example, merely still 2 centimeters then also a person outside the elevator car is never at risk, because under no circumstances can any person ever climb down into the elevator shaft pit, since this access is prevented by the claimed technical measures. The required free space or protective space for the service operative is formed by the elevator car itself when the operative is in the elevator car, or is formed above the same if the elevator shaft head has a sufficient height, so that the required protective space on reaching the uppermost development plane is present. However, there can only be a question of a protective space formed by the elevator car itself if all maintenance operations can be performed from the interior of the elevator car and therefore a presence in the elevator shaft, whether above or below the elevator car, is never necessary and therefore this access is made impossible from the outset by technical measures.

### DESCRIPTION OF THE DRAWINGS

The principle is shown in the drawings and explained in the following on the basis thereof, wherein:

FIG. 1 shows an elevator with four access levels, with minimal elevator shaft pit depth, with the elevator car in the uppermost access level;

FIG. 2 shows this elevator with four access levels, with the elevator car in the second-uppermost access level; and

FIG. 3 shows this elevator with four access levels, with the elevator car in the lowermost access level.

### DETAILED DESCRIPTION OF THE INVENTION

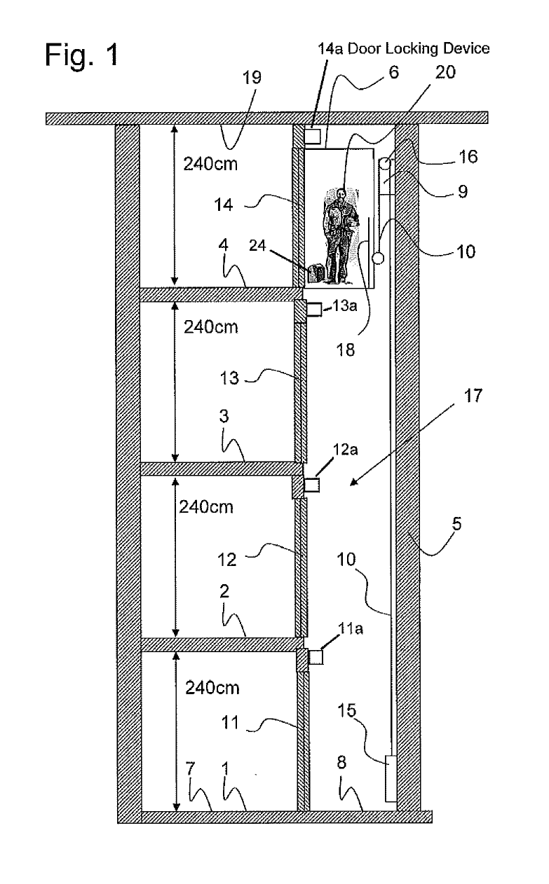

FIG. 1 shows a cross-section through a building with four access levels 1 to 4, which are all accessed by the elevator car 6 of the elevator. The principle on which this invention is based is explained by way of this drawing. In that case, however, it is clear that such an elevator can be guided over fewer or also many more levels. In addition, the drive can be resolved differently from that illustrated here and includes all known drive variants, regardless of kind. The construction shown here is thus solely an exemplifying construction and is not in any way to be understood as restricting the scope of protection. The elevator shaft 5 belonging to this elevator is here virtually the same height as the distance between the floor 7 of the lowermost access level 1 and the ceiling 19 of the uppermost access level 4. The elevator car 6 is here in its uppermost position, i.e. on the uppermost access level 4. If the elevator car 6 subsequently lies in its lowermost position virtually on the lowermost access level 1 then the car floor thereof, which does also have a certain thickness, lies by its upper side in the same plane as the finished floor covering 7 of the lowermost access level 1. The protective space F of this elevator is always and permanently formed by the elevator car 6 itself, as will be still explained. The drive of this elevator is carried out in the illustrated example by a drive unit in the form of a gearless external rotor, which is fastened in a frame 9 to the shaft wall and is supported on guide rails (not illustrated). The external rotor forms a drive pulley 16 and the support means 10, which on the one hand carry the elevator car 6 and on the other hand the counterweights 15, run over this. The elevator car 6 is as usual guided along rails which are anchored to the elevator shaft wall, but are not illustrated here. The elevator car 6 can in the illustrated example be moved past this drive unit. A wall part 18 of the elevator car 6 can be removed and then access to parts, which have to be maintained, is ensured for the service operative 20, so that the maintenance operations can be carried out by him or her from the elevator car 6, as described in detail in, for example, WO 2008/095324.

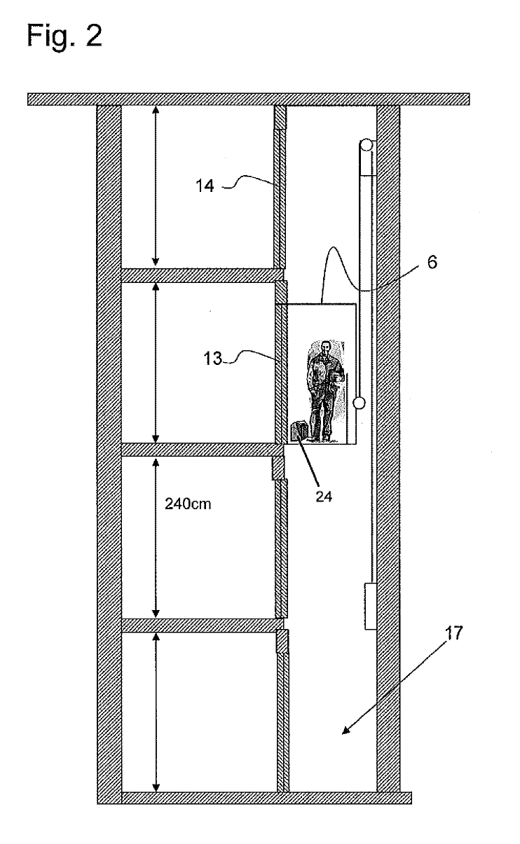

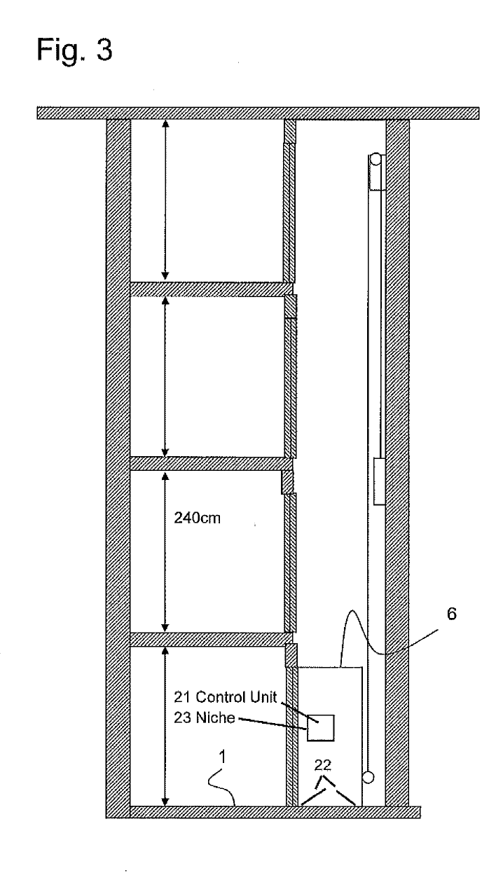

What is the situation with regard to the region below the elevator car? If anybody is there then this person would be crushed on downward movement of the elevator car to the lowermost access level 1. In the lowermost position of the elevator car 6 it virtually stands on the floor 8 of the elevator shaft 5, as can be seen on the basis of FIG. 3. How is it possible to thus securely and effectively prevent anybody from being trapped between the underside of the elevator car 6 and the floor 8 of the elevator shaft 5. According to the invention that is managed in such a way that the entire region 17 below the elevator car 6, as it is designated in FIGS. 1 and 2, is safeguarded by technical precautions so as to never be able to be entered. Consequently, nobody can ever be in this region 17 and therefore also nobody can ever come to harm by complete downward movement of the elevator car 6 to the lowermost access level 1.

These technical precautions consist in that at least the shaft door 11 is permanently lockable. In a particularly preferred alternative embodiment the shaft doors 11 to 13, with the exception of the door 14 of the uppermost access level, are not opened as long as the elevator car 6 is stopped at the corresponding access level. In conventional elevators the shaft doors can usually be unlocked and opened in the case of emergency by a box spanner. Depending on where the elevator car is currently located it is then possible when the shaft door is open to look onto it from above or from below onto the elevator car located further above and access into the elevator shaft is possible through any shaft door, even access into the elevator shaft below the elevator car. If a conventional elevator thus has a shaft pit, then this is always accessible in that the elevator is moved into a position above the lowermost access level and thereafter the lowermost shaft door can be unlocked, whereafter it is possible to climb down into the shaft pit, for example to carry out whatever maintenance operations there, in order to clean something or, for example, in order to extract an object which unintentionally fell into the pit. This access has to be accompanied on every occasion by a temporary protective precaution which ensures that the elevator car cannot travel beyond the standing region in the shaft pit and thus that a minimum protective space F below the elevator car of at least the size of a block F with the minimum dimensions of 0.5 meters×0.6 meters×1.0 meter is always present. Thus, for example, a temporary support is mounted or downward travel of the elevator car is blocked by a temporary lock so as to ensure the presence of the protective space F.

In the case of the elevator presented here, however, walking into the region 17 below the elevator car 6 is in general, i.e. in all conceivable cases, made absolutely impossible by way of technical precautions. Accordingly, there is also at no time a risk of a person being able to come to harm below the elevator car 6 by downward travel thereof. As mentioned, the technical precautions consist in that at least the shaft door 11 is always locked when the elevator car 6 is not currently located at the relevant access level. Thus, only when the elevator car 6, for example, stops on the access level 1 can the shaft door 11 present thereat open. At least the lowermost shaft door 11 accordingly has absolutely no emergency unlocking even if intended and therefore can never be opened from the outside if the elevator car is not currently stopped in front of this shaft door 11. The elevator car 6 can move away only if the previously opened shaft door 11 is firstly closed again and locked. The shaft door 11 offers solely access to the interior of the elevator car 6, but never into the interior of the elevator shaft 17 above or below the elevator car. Only one or more shaft doors 12-14 allow both access to the interior of the elevator car 6 and access to the region above the elevator car 6 according to whether or not these shaft doors 12-14 have emergency unlocking means. Access to the elevator car 6 is made possible obviously when the elevator car 6 is stopped at one of the access levels 2-4. If, however, the elevator car 6 is stopped at an access level 1-3 below a shaft door 12-14 which is unlockable in emergency, the respective shaft door 12-14, by way of an intrinsic emergency unlocking, if present, makes possible access to the elevator shaft 17, but exclusively to the region above the elevator car 6 and never below the same. In the case of a shaft door 12, which has emergency unlocking means, directly above the lowermost shaft door 11 and in the case of a position of the elevator car 6 above the shaft door 12, for example, access into the elevator shaft 17 is equally impossible, since falling into the shaft pit does not count as access to the elevator shaft. Each of the doors 11-14 is provided with a door locking device 11a-14a respectively that can function as either or both of the permanent locking means and the emergency unlocking means.

The elevator shaft 17 is thus accessible solely by way of the upper shaft doors 12-14, by way of emergency unlocking means, which is not intentionally present at least at the lowermost shaft door 11. Nothing can ever happen below the elevator car 6, because this region is for technical reasons never accessible and a protective space below the elevator car is therefore superfluous. The service operative is present on the car with sufficient protective space or appropriate protective measures or only in the interior of the elevator car 6, which at the same time forms the permanent protective space. The special feature of a permanent protective space consists in that protection to the full scope is always and generally guaranteed in the elevator car without any form of measures having to be initially undertaken and without any form of special precautions or changes having to be initially carried out. A protective space, thereagainst, protruding only partly into the elevator car counts according to the regulations as temporary and thus not as a permanent protective space, because something firstly has to happen at the car roof in order for it to arise. Similarly, only a temporary protective space is present when, for example, initially a safety circuit has to be activated or a drive has to be blocked or a support has to be set in place or folded down or any other kind of measures have to be undertaken in order to ensure the presence of a protective space.

In a further embodiment of the elevator one or more shaft doors 12-14 above the shaft door 11 of the of the lowermost access level 11 have emergency unlocking means.

In yet another embodiment of the elevator solely the uppermost shaft door 14 has emergency unlocking means.

In yet a further embodiment of the elevator all shaft doors 11-14 are permanently lockable. In this embodiment neither access below the elevator car 6 to the elevator shaft pit nor access above the elevator car 6 to the elevator shaft 17 is possible. Thus, for maintenance purposes only the car interior can be reached. Correspondingly, the elevator car 6 has a maintenance opening so as to enable maintenance operations from the car interior of the elevator car 6.

In the three above-mentioned embodiments of the elevator in addition to the lowermost shaft door 11 also further shaft doors 12-14 are permanently lockable. Correspondingly, these additional permanently lockable shaft doors 12-14 open only when an elevator car 6 travels into the region of the respect access level 2-4 or stops at this access level 2-4. Those shaft doors 12-14, which have emergency unlocking means, then free access to the elevator shaft 17 in the region above the elevator car 6 when the elevator car 6 is positioned at an access level 11-13 below the respective shaft door 12-14.

For constructional reasons at least the lowermost shaft door 11 cannot, in fact, be unlocked if the elevator car 6 is not at the level of the shaft door concerned. Thereagainst, one or more upper shaft doors 12-14 are unlockable from outside depending on whether they have emergency unlocking means. If the elevator car 6 has stopped in front of a shaft door, the shaft door opens in conventional manner. In this case, the service operative can go into the interior of the elevator car 6 and check everything at the shaft door as well as at the elevator car door, which is also visible to normal elevator users. However, in this position of the elevator car the service operative cannot check or repair at least the mechanism and control of the shaft doors 11. If further, upper shaft doors 12-14 are permanently lockable then also the mechanism and control thereof are checkable or repairable neither from outside nor from the car interior. The door drive and the locking mechanism of the shaft doors 11-14 are disposed, in particular, above the interior ceiling of the elevator car. In order that these parts are nevertheless accessible for maintenance and possibly necessary repair this elevator allows the possibility of movement into the service mode from the closed elevator car. For that purpose the elevator car 6 can have, for example, a removable cover part, wall part or light part, behind which the control 21 of the elevator drive for the service mode is concealed, for example in the form of a stationary control strip or a removable control strip, which hangs at a cable, so that the service operative has freedom of movement and can be in any desired position in the interior of the closed elevator car and nevertheless conveniently actuate the control and travel up and down in the service mode. The control unit 21 can also be installed in a niche 23 in the interior of the elevator car, which is closable by a sliding door or panel door, or by a separate cover which can be fitted in place. Moreover, the control unit 21 can also be realized in that plug positions are provided at the inner side of the elevator car, for example USB plug positions. The service operative then brings his or her control apparatus 24 with them or stores this at a suitable place in. the elevator, and the operative then produces by way of the plug positions the electrical connections with the drive and its electronic control system so that the operative can travel up and down in the closed elevator car in the service mode. The control unit 21 can also be realized wirelessly. The service operative then has a transmitter 24 which acts on the elevator car by way of a wireless interface 21. Finally, the control unit 21 for travel of the closed elevator car in the service mode can also function through a specific button combination at an already-present keyboard, or through specific button combinations at a separate keyboard plugged into the elevator car in a niche. The service mode makes it possible to move the elevator slowly as desired and stop it at any desired position. Correspondingly, the service operative can, from a specific access level in the service mode, move up somewhat slowly from the closed elevator car, for example approximately a meter, and then open the elevator car door. The operative is located directly in front of the shaft door drive in the upper region of the shaft doors of the associated access level. The shaft doors are now somewhat further down relative to the elevator car and the service operative is granted ideal access to all components of the shaft door drive. If necessary, the operative can close the car doors again and travel somewhat further upwards or downwards centimeter-by-centimeter to any point desired by him or her. At the desired point the operative can thereafter open the car doors again and carry out work.

If for whatever reasons an object should drop down between the car door and a shaft door into the elevator shaft then this can be secured again in that the floor of the elevator car 6 can be partly or entirely removed from the elevator car. The floor of the elevator car can for that purpose have slides or can have door panels 22 which can be folded up into the elevator car 6, so that the entire elevator shaft floor is reachable by a tool and objects can be secured by him or her. In addition, if, for example, a liquid has been spilled or oil has run out then this could be readily removed from the shaft floor via this opening hatch.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. An elevator with an elevator car that is a movable in an elevator shaft to a plurality of access levels, and with a plurality of shaft doors that are arranged on the respective access levels and close off access to the elevator shaft, comprising: at least a one of the shaft doors at a lowermost of the access levels having a door locking device being permanently lockable.

14. The elevator according to claim 13 wherein at least one of the shaft doors above the lowermost access level has a door locking device for emergency unlocking.

15. The elevator according to claim 13 wherein only an uppermost one of the shaft doors has a door locking device for emergency unlocking.

16. The elevator according to claim 13 wherein all of the shaft doors have a door locking device being permanently lockable.

17. The elevator according to claim 13 wherein a floor of the elevator car is at least partially openable so that when the elevator car is stopped at the lowermost access level a region of a shaft floor of the elevator shaft is accessible from the interior of the elevator car for maintenance and servicing operations.

18. The elevator according to claim 17 wherein the floor of the elevator car has at least one panel that can be folded up into the elevator car interior in order to open the floor.

19. The elevator according to claim 17 wherein the floor of the elevator car has at least one base region constructed as a slide laterally displaceable to open the floor.

20. The elevator according to claim 13 wherein when car doors of the elevator car are closed, the elevator car is controllable from an interior to move in a service mode.

21. The elevator according to claim 20 wherein when the car doors are closed, the elevator car is controllable from outside the interior to move in the service mode, the elevator car including a cable-supported control apparatus accommodated in the interior of the elevator car in a niche that is covered and secured by a cover, a door or a slide and the control apparatus is removable when the cover, door or slide is opened.

22. The elevator according to claim 20 wherein when the car doors are closed, the elevator car is controllable from the interior to move in the service mode and the elevator car has in the interior plug positions for creating a cable connection with a portable control apparatus.

23. The elevator according to claim 20 wherein when the car doors are closed, the elevator car is controllable from the interior to move in the service mode, including a wireless transmitter control apparatus and the elevator car is equipped with a wireless interface responsive to activation of the wireless transmitter to control an elevator drive for the elevator car.

24. The elevator according to claim 20 wherein when the car doors are closed, the elevator car is controllable from the interior to move in the service mode and including a specific button combination for control of the service mode being assigned to an existing keyboard or a special keyboard in the interior of the elevator car.
